(19) United States
(12) Patent Application Publication
(10) Pub. No.: US 2019/0367081 A1
(43) Pub. Date: Dec. 5, 2019

(54) METHOD AND SYSTEM FOR TESTING OF SYSTEMS

(71) Applicant: GM GLOBAL TECHNOLOGY OPERATIONS LLC, Detroit, MI (US)

(72) Inventors: Ian Y. Hwa, West Bloomfield, MI (US); Jarred J. Versical, Commerce Twp, MI (US)

(21) Appl. No.: 15/995,776

(22) Filed: Jun. 1, 2018

(51) Int. Cl. B62D 5/04; G07C 5/08; H04L 9/32

(52) U.S. Cl. CPC B62D 5/0481; H04L 9/3242; G07C 5/0808

(57) ABSTRACT

A system and method include receiving, by an interface device, test information including a test message from testing equipment. The interface device is configured to interface between the testing equipment and a test specimen. The method also includes converting, by the interface device, the test information into at least one proprietary message. The proprietary message is proprietary to an original-equipment-manufacturer or integrator of the test specimen. The method also includes transmitting the at least one proprietary message to the test specimen. The test specimen is tested based on the at least one proprietary message.

### INTRODUCTION

The subject embodiments relate to testing of systems. Specifically, one or more embodiments can be directed to a method for communicating between test equipment and a system that is to be tested, for example.

Test equipment can be connected to a system that is to be tested (i.e., a test specimen to be tested). The test equipment can generate test messages which are then transmitted to the test specimen. Upon receiving the generated test messages, the test specimen can behaviorally and electrically respond. The electrical response of the test specimen can be used to send feedback to the test equipment.

### SUMMARY

In one exemplary embodiment, a method includes receiving, by an interface device, a test message from testing equipment. The interface device is configured to interface between the testing equipment and a test specimen. The method also includes converting, by the interface device, the test message into at least one proprietary message. The proprietary message may be proprietary to an original-equipment-manufacturer of the test specimen or an integrator of the test specimen. The method also includes transmitting the at least one proprietary message to the test specimen. The test specimen's behavior is based on the at least one proprietary message.

In another exemplary embodiment, the test specimen includes an electric power steering system.

In another exemplary embodiment, the method also includes applying, by the interface device, cybersecurity measures to the proprietary message.

In another exemplary embodiment, applying the cybersecurity measures includes adding information relating to at least one of a checksum, a protection value, a rolling-count value, a message authentication protocol, or a form of key dependent message.

In another exemplary embodiment, the converting includes converting the test message into at least one proprietary controller-area-network message.

In another exemplary embodiment, the test message includes a plurality of signals, and each signal corresponds to a parameter that is to be input into the test specimen for testing purposes.

In another exemplary embodiment, the plurality of signals includes at least one signal that corresponds to a steering-angle input.

In another exemplary embodiment, the plurality of signals includes at least one signal that corresponds to a yaw rate.

In another exemplary embodiment, the method also includes receiving by the interface device a response from the test specimen whose behavior is responsive to the at least one proprietary message.

In another exemplary embodiment, the method also includes that the response is a proprietary message that is proprietary to an original-equipment-manufacturer of the test specimen or an integrator thereof.

In another exemplary embodiment, the method also includes converting the response into a message format utilized by the testing equipment, and transmitting a converted message to the test equipment.

In another exemplary embodiment, the method also includes converting the response message into a format utilized by the testing equipment, and transmitting the converted response message to the test equipment.

In another exemplary embodiment, a system for testing systems includes an electronic controller of an interface device configured to receive a test message from the testing equipment. The electronic controller is configured to interface between the testing equipment and a test specimen. The electronic controller is also configured to convert the test message into at least one proprietary message. The proprietary message is proprietary to an original-equipment-manufacturer of the test specimen or an integrator thereof. The electronic controller is also configured to transmit the at least one proprietary message to the test specimen. The test specimen's behavior is based on the at least one proprietary message.

In another exemplary embodiment, the test specimen includes an electric power steering system.

In another exemplary embodiment, the electronic controller is further configured to apply cybersecurity measures to the proprietary message.

In another exemplary embodiment, applying the cybersecurity measures includes adding information relating to at least one of a checksum, a protection value, a rolling-count value, a message authentication protocol, or a form of key dependent message.

In another exemplary embodiment, the converting includes converting the test message into at least one proprietary controller-area-network message.

In another exemplary embodiment, the test message includes a plurality of signals, and each signal corresponds to a parameter that is to be input into the test specimen for testing purposes.

In another exemplary embodiment, the plurality of signals includes at least one signal that corresponds to a steering-angle input.

In another exemplary embodiment, the plurality of signals includes at least one signal that corresponds to a yaw rate.

In another exemplary embodiment, the interface device is further configured to receive a response from the test specimen whose behavior is responsive to the at least one proprietary message.

In another exemplary embodiment, the response is a proprietary message that is proprietary to an original-equipment-manufacturer of the test specimen or an integrator thereof.

In another exemplary embodiment, the interface device is further configured to convert the response into a message format utilized by the testing equipment, and transmit the converted message to the test equipment.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 illustrates a system that tests systems in accordance with one or more embodiments;

FIG. 2 illustrates a method of transmitting communication between test equipment, an interface, and a test specimen in accordance with one or more embodiments;

FIG. 3 illustrates an example process of converting at least one test message, applying cybersecurity, and placing data in accordance with one or more embodiments;

FIG. 4 depicts a flowchart of a method in accordance with one or more embodiments; and

FIG. 5 depicts a high-level block diagram of a computing system, which can be used to implement one or more embodiments.

### DETAILED DESCRIPTION

The following description is merely exemplary in nature and is not intended to limit the present disclosure, its application or uses. As used herein, the term device refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

As described above, one or more embodiments can be directed to a method for communicating between test equipment and a test specimen. Specifically, one or more embodiments are directed to a system and method for enabling communication between the test equipment (that is only capable of transmitting generic testing messages) and a test specimen (of an original-equipment-manufacturer (OEM) or an integrator of the test specimen hereinafter identified as the OEM for simplicity). The test specimen can be, for example, an electric power steering system.

As described above, the communication between the test equipment and the test specimen can include a variety of information including test messages, responses, physical responses as may be measured by sensors, as well as response messages. When the test equipment sends test messages to the test specimen, the test equipment provides for control actions directed to the test specimen in order to determine whether the test specimen responds as expected. After the test equipment sends the test messages toward the test specimen, the test messages may need to be converted into a messaging format that is recognizable/receivable by the test specimen. For example, the test specimen can use a messaging format that is proprietary to the OEM or integrator of the test specimen. Further, the test messages may need to be supplemented with additional information including, but not limited to, cybersecurity information in order to be recognized/received by the test specimen. Electrical systems are increasingly secured by using cybersecurity technology in order to protect the exchanged communication from unwanted outside intrusion/interference.

Suppliers of conventional test equipment generally may not comprehend the proprietary technical details relating to the proprietary communication and the cybersecurity that is implemented by the test specimen. Further, the OEM of the test specimen or the integrator generally, may not want to disclose such details to the suppliers of the test equipment. Further, due to changes in design, proprietary communication protocols over time, updates to the proprietary communication and cybersecurity would be required at some expense. By avoiding disclosure of the proprietary details of the communication and the implemented cybersecurity to the suppliers of the test equipment, the OEM of the test specimen can more securely protect the test specimen from unauthorized tampering/intrusion by others.

However, in order to enable the test equipment to transmit test messaging that is recognizable/acceptable to the test specimen, the conventional approaches typically require the OEM (of the test specimen) to disclose details relating to test specimen's proprietary messaging and the test specimen's cybersecurity measures.

For example, with the conventional approaches, the OEM may need to disclose (to the suppliers of the test equipment) technical details regarding the electrical architecture of the test specimen, details regarding the applied cybersecurity measures, and/or details regarding the proprietary messaging format of the test specimen.

In contrast to the conventional approaches, one or more embodiments are directed to an interface device that facilitates communication between the test equipment and the test specimen, without requiring the OEM of the test specimen to disclose any details regarding the proprietary messaging of the test specimen, and without requiring the OEM to disclose any details regarding the cybersecurity that is implemented on behalf of the test specimen. One or more embodiments enable testing messages and response messages to be communicated between the test equipment and the test specimen. The interface device of one or more embodiments can also enable users to perform testing of the test specimen at a lower cost compared to the conventional approaches.

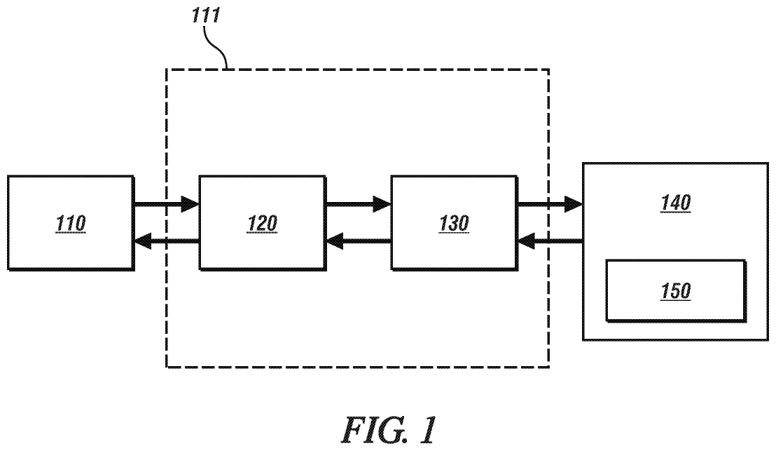

FIG. 1 illustrates a system that tests systems in accordance with one or more embodiments. As described above, testing equipment 110 can be used to perform testing of a test specimen 140. In one example, test specimen 140 can correspond to an electric power steering system. Test specimen 140 can also include one or more electronic control units (ECUs) 150, for example. One or more embodiments can be directed to an interface 111 that facilitates communication between testing equipment 110 and test specimen 140. Interface 111 can include a conversion device 120 and a controller-area-network simulation device 130. As described above, test specimen 140 can be configured to receive messages that are formatted according to a proprietary format. For example, test specimen 140 can be configured to receive proprietary controller-area-network (CAN) messages. As described in more detail herein, with one or more embodiments, the messaging between testing equipment 110 and interface 111 is performed using a general messaging format that is provided/utilized by testing equipment 110. Interface 111 does not communicate with test equipment 110 using the proprietary CAN messages that are used by test specimen 140. Thus, interface 111 effectively blocks test equipment 110 from receiving and comprehending the proprietary CAN messages and cybersecurity measures that are utilized by test specimen 140. While the described embodiments are made with reference to communication employing CAN, such reference is for illustration only. The communication could also employ a variety of architectures & technologies, such as CAN (and any technology subsets), LIN, FlexRay, Ethernet (and any technology subsets), Serial data, and the like.

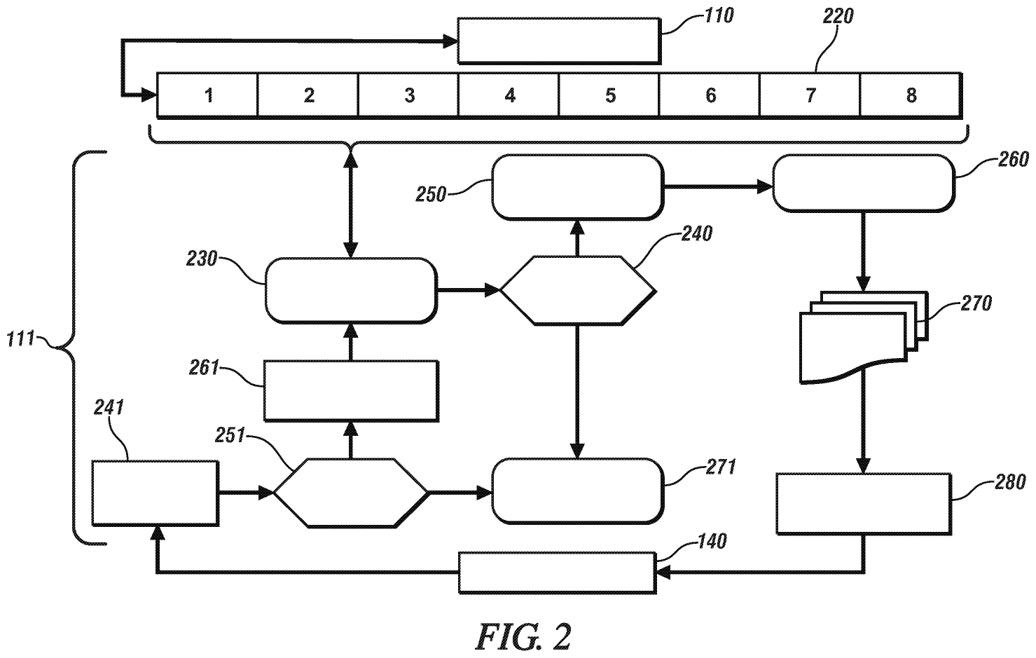

FIG. 2 illustrates a method of transmitting communication between test equipment 110, an interface device 111, and a test specimen 140 in accordance with one or more embodiments. As described herein, test equipment 110 can transmit test information that includes, but is not limited to a test message 220 to conversion device 120 of interface device 111 (as shown by FIG. 1). Test message 220 can include a plurality of signals such as signals 1-8, for example. Although the example of FIG. 2 illustrates a test message of eight signals, other test messages can include any number of signals. Testing equipment 110 can transmit signals relating to any type of parameter that is to be input into the test specimen 140 for testing purposes. For example, some test information could include simulations of analog and digital sensor information. For example, in the example of an electric power steering system, the testing equipment 110 can transmit signals relating to steering-angle inputs, among others, to test specimen 140.

Test equipment 110 can transmit test message 220 to the test specimen 140 via interface device 111 (as shown by FIG. 1). At 230, conversion device 120 receives signals 1-8 from test equipment 110. Each of signals 1-8 can correspond to a signal in intra-vehicle communication. For example, a signal can correspond to a yaw rate, an instruction to apply torque, ignition status, other information that the test specimen may need, and/or any other information that performs synchronization between test equipment 110 and test specimen 140. At 240, conversion device 120 parses the overall message and determines whether some or all of the received information (corresponding to signals 1-8) should be transmitted to the test specimen 140 for further processing. For example, it should be appreciated that some test cases may not have relevant information for the test specimen 140. Some tests may not need to send all of the signals, so some can be ignored. Moreover, some test cases may not have all the received information (e.g., signals 1-8) populated. In this case, the signals populated/relevant to the test should continue with the process, while the non-populated signals may be rejected or set to default values. Other tests may trigger faults, causing previously sent information to be stopped. Thus, measuring the test specimen's response for safety and control logic purposes may be advantageous. As a result, more specifically, conversion device 120 determines which of the received information is relevant to be further transmitted to test specimen 140. If conversion device 120 determines that the received information does not need to be transmitted, then one or more embodiments ignores the received information at 271. On the other hand, if conversion device 120 determines that the received information needs to be provided, then, at 250, conversion device 120 can convert the received information into one or more proprietary signals that are receivable by the test specimen 140. For example, the received information can be converted into one or more proprietary CAN signals.

At 260, conversion device 120 can include additional signals with or in the message that originates from the test equipment 110, or static values configured for a particular test or situation. For example, in an embodiment the conversion device 120 may apply or define selected values, speeds, forward/reverse data based on the values, or cybersecurity measures to the proprietary CAN signals. The cybersecurity measures can include adding information relating to one or more of, at least, checksums, protection value, rolling count values, a message authentication protocol, and/or a key dependent message, for example. The cybersecurity measures can be measures that are proprietary to the OEM/integrator of the test specimen 140.

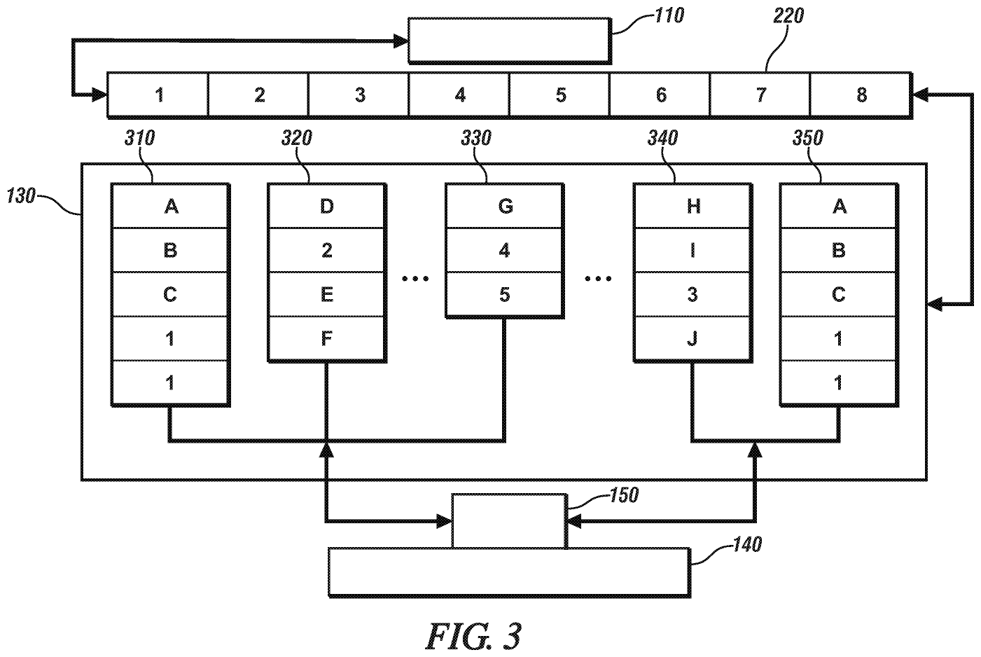

At 270, conversion device 120 can perform placement of the data, where the data corresponds to one or more OEM/integrator CAN signals that include cybersecurity measures. Specifically, placement of the data corresponds to formatting the data and directing the data to the test specimen 140 (as is depicted by FIG. 3).

At 280, network simulation device 130 (of FIG. 1) can broadcast the placed data to test specimen 140. Network simulation device 130 can broadcast the placed data in the form of OEM/integrator CAN signals with implemented cybersecurity. Network simulation device 130 broadcasts the placed data to test specimen 140. Test specimen 140 then receives the placed data, and test specimen 140 can be tested based on the received placed data.

As test specimen 140 is tested, test specimen 140 generates responses based on the specific test messages (or subset thereof) received from the conversion device 120. Responses of the test specimen 140 can include, but not be limited to, measured responses, mechanical and dynamic responses to the test messages, as well as transmitted status, sensor value changes, diagnostic information, and the like. Responses may also include changes in the operating characteristics, behavior, status, or even a lack of change of status from which information may be inferred of the test specimen 140. Referring again to FIG. 2, at 241, network simulation device 130 receives and collects various information corresponding to various responses of the test specimen 140 undergoing testing, as well as communication messages that may include information indicative of results and responses from the test specimen 140 to the test message 220 (or subset thereof) from the test equipment. The information transmitted by the test specimen 140 can be in the form of proprietary network format of the OEM CAN signals with implemented cybersecurity. At 251, conversion device 120 may determine if the received information causes a status change for the test equipment 110. If the received information causes a status change (i.e., a relevant change in testing results from the test specimen 140), then the received information is relevant to be further transmitted to test equipment 110. If the conversion device 120 determines that the received information is relevant, then the received information can be converted into messages (that can be transmitted to and are receivable by test equipment 110, e.g., in the format depicted in FIG. 3) by removing the applied cybersecurity measures and by converting the OEM CAN signals into the general messages that can be recognized by test equipment 110 at 261. If the conversion device 120 determines that the received information is not relevant, then the information is ignored at 271. At 230, conversion device 120 can transmit the converted information to test equipment 110.

FIG. 3 illustrates an example process of converting at least one test message 220 from the test equipment 110 (see FIG. 1), applying cybersecurity measures, and placing data in accordance with one or more embodiments. As described herein, a conversion device 120 and a network simulation device 130 can convert at least one test message transmitted by test equipment 110 into a message that is receivable by test specimen 140. In the example of FIG. 3, message 220 is converted into a plurality of proprietary messages (i.e., message 310, 320, 330, 340, and 350) that are receivable by test specimen 140. As discussed herein, one or more embodiments can convert message 220 into OEM CAN signals with implemented cybersecurity. As such, messages 310-350 can correspond to OEM CAN signals with implemented cybersecurity.

Referring to FIG. 3, message 310 can correspond to one or more OEM CAN signals with implemented cybersecurity; specifically, message 310 includes signal A, signal B, and signal C, which can correspond to added cybersecurity measures/information. Further, the signals included in the message can originate from the test equipment 110, or be static values configured for a particular test or situation. Message 310 can also include portions of information from message 220. For example, in addition to signals A through C, message 310 also includes two instances of signal 1.

Message 320 includes an instance of signal 2 (from message 220) along with signal D, signal E, and signal F. Signals D, E, and F can correspond to cybersecurity measures that are added to and included with message 320.

Message 330 includes an instance of signal 4 and an instance of signal 5. Message 330 can also include an instance of signal G. Signal G can correspond to a cybersecurity measure that is added to message 330.

After message 220 is converted into messages 310-350, an electronic control unit (ECU) 150 of the test specimen 140 can receive messages 310-350. The electronic control unit 150 is also configured to receive and utilize the at least one proprietary message. The proprietary message is proprietary to an original-equipment-manufacturer of the test specimen or an integrator thereof. The electronic control unit 150 is also configured to direct the test specimen 140 in accordance with the information in the at least one proprietary message. The test specimen's behavior and response is then based on the at least one proprietary message.

As test specimen 140 is tested, test specimen 140 and ECU 150 generate responses based on the specific test messages (or subset thereof) received. As stated above, responses of the test specimen 140 can include measured responses, status, diagnostic information, as well as changes in the operating characteristics, behavior, and the like. Electronic control unit 150 receives and collects various information corresponding to various responses of the test specimen 140 as well as communication messages that may include information indicative of results and responses from the test specimen 140 based on the test messages e.g., 310-350 (or subset thereof).

The electronic control unit 150 is also configured to generate and broad cast various responses and messages in the message format proprietary to an original-equipment-manufacturer of the test specimen 140 or an integrator thereof including adding any cybersecurity measures employed by the proprietary format. The electronic control unit 150 is also transmit the responses and information to the interface device 111 in a format similar to messages 310-350.

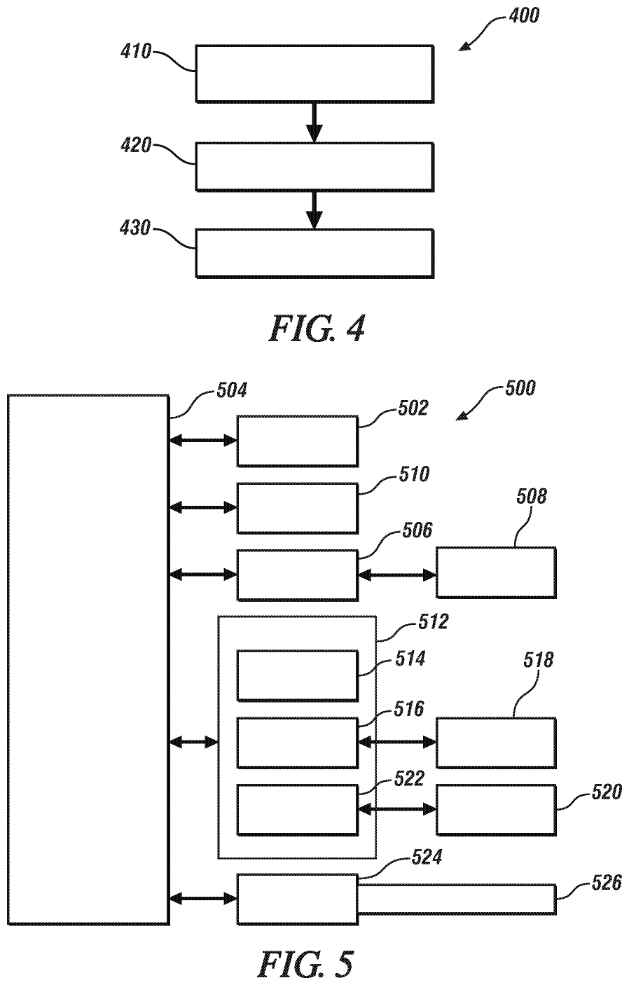

FIG. 4 depicts a flowchart of a method 400 in accordance with one or more embodiments. The method of FIG. 4 can be performed in order to test systems. The method of FIG. 4 can be performed by a controller in conjunction with testing equipment. The method can include, at block 410, receiving, by an interface device, a test message from testing equipment 110. The interface device is configured to interface between the testing equipment 110 and a test specimen 140. The method can also include, at 420, converting, by the interface device, the test message into at least one proprietary message. The proprietary message is proprietary to an original-equipment-manufacturer of the test specimen or an integrator thereof. The method can also include, at 430, transmitting the at least one proprietary message to the test specimen 140. The test specimen's behavior and response is then based on the at least one proprietary message.

FIG. 5 depicts a high-level block diagram of a computing system 500, which can be used to implement one or more embodiments. Computing system 500 can correspond to, at least, a system that is configured to test various systems, for example. Computing system 500 can correspond to an interface device, a conversion device, and/or a network simulation device. Computing system 500 can be used to implement hardware components of systems capable of performing methods described herein. Although one exemplary computing system 500 is shown, computing system 500 includes a communication path 526, which connects computing system 500 to additional systems (not depicted). Computing system 500 and additional system are in communication via communication path 526, e.g., to communicate data between them.

Computing system 500 includes one or more processors, such as processor 502. Processor 502 is connected to a communication infrastructure 504 (e.g., a communications bus, cross-over bar, or network). Computing system 500 can include a display interface 506 that forwards graphics, textual content, and other data from communication infrastructure 504 (or from a frame buffer not shown) for display on a display unit 508. Computing system 500 also includes a main memory 510, preferably random access memory (RAM), and can also include a secondary memory 512. There also can be one or more disk drives 514 contained within secondary memory 512. Removable storage drive 516 reads from and/or writes to a removable storage unit 518. As will be appreciated, removable storage unit 518 includes a computer-readable medium having stored therein computer software and/or data.

In alternative embodiments, secondary memory 512 can include other similar means for allowing computer programs or other instructions to be loaded into the computing system. Such means can include, for example, a removable storage unit 520 and an interface 522.

In the present description, the terms “computer program medium,” “computer usable medium,” and “computer-readable medium” are used to refer to media such as main memory 510 and secondary memory 512, removable storage drive 516, and a disk installed in disk drive 514. Computer programs (also called computer control logic) are stored in main memory 510 and/or secondary memory 512. Computer programs also can be received via communications interface 524. Such computer programs, when run, enable the computing system to perform the features discussed herein. In particular, the computer programs, when run, enable processor 502 to perform the features of the computing system. Accordingly, such computer programs represent controllers of the computing system. Thus it can be seen from the forgoing detailed description that one or more embodiments provide technical benefits and advantages.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the embodiments not be limited to the particular embodiments disclosed, but will include all embodiments falling within the scope of the application.

What is claimed is:

1. A method, the method comprising:
receiving, by an interface device, test information from testing equipment, wherein the interface device is configured to interface between the testing equipment and a test specimen;
converting, by the interface device, the test information into at least one proprietary message, wherein the proprietary message is proprietary to an original-equipment-manufacturer of the test specimen or an integrator thereof; and
transmitting the at least one proprietary message to the test specimen, wherein the test specimen is responsive based on the at least one proprietary message.

2. The method of claim 1, wherein the test information is a test message.

3. The method of claim 1, further comprising applying, by the interface device, cybersecurity measures to the proprietary message.

4. The method of claim 3, wherein applying the cybersecurity measures comprises adding information relating to at least one of a checksum, a rolling-count value, a message authentication protocol, or a form of key dependent message.

5. The method of claim 1, wherein the converting comprises converting the test information into at least one proprietary controller-area-network message.

6. The method of claim 1, wherein the test message comprises a plurality of signals, and each signal corresponds to a parameter that is to be input into the test specimen for testing purposes.

7. The method of claim 6, wherein the test specimen is an electric power steering system and the plurality of signals comprises at least one signal that corresponds to at least one of a steering-angle input and a yaw rate.

8. The method of claim 1, further comprising receiving by the interface device a response from the test specimen whose behavior is responsive to the at least one proprietary message.

9. The method of claim 8, wherein the response is a proprietary message that is proprietary to an original-equipment-manufacturer of the test specimen or an integrator thereof.

10. The method of claim 8, further comprising converting the response into a message format utilized by the testing equipment, and transmitting a converted message to the test equipment.

11. A system for testing systems, comprising an electronic controller of an interface device configured to:
receive test information from testing equipment, wherein the interface device is configured to interface between the testing equipment and a test specimen;
convert the test information into at least one proprietary message, wherein the proprietary message is proprietary to an original-equipment-manufacturer of the test specimen or an integrator thereof; and
transmit the at least one proprietary message to the test specimen, wherein the test specimen is responsive based on the at least one proprietary message.

12. The system of claim 11, wherein the test specimen comprises at least a component of an electric power steering system.

13. The system of claim 11, wherein the electronic controller is further configured to apply cybersecurity measures to the proprietary message.

14. The system of claim 13, wherein applying the cybersecurity measures comprises adding information relating to at least one of a checksum, a rolling-count value, a message authentication protocol, or a form of key dependent message.

15. The system of claim 11, wherein the converting comprises converting the test information into at least one proprietary controller-area-network message.

16. The system of claim 11, wherein the test message comprises a plurality of signals, and each signal corresponds to a parameter that is to be input into the test specimen for testing purposes.

17. The system of claim 16, wherein the plurality of signals comprises at least one signal that corresponds to a steering-angle input.

18. The system of claim 16, wherein the plurality of signals comprises at least one signal that corresponds to a yaw rate.

19. The system of claim 11, wherein the interface device is further configured to receive a response from the test specimen whose behavior is responsive to the at least one proprietary message, and wherein the response is a proprietary message that is proprietary to an original-equipment-manufacturer of the test specimen or an integrator thereof.

20. The system of claim 19, wherein the interface device is further configured to convert the response into a message format utilized by the testing equipment, and transmit the converted message to the test equipment.
